(19) United States
(12) Patent Application Publication
(10) Pub. No.: US 2023/0194366 A1
(43) Pub. Date: Jun. 22, 2023

(54) FORCE SENSING DEVICE

(71) Applicant: Peratech Holdco Limited, North Yorkshire (GB)

(72) Inventor: Ramin LOLACHI, Belmont (GB)

(21) Appl. No.: 18/108,071

(22) Filed: Feb. 10, 2023

Related U.S. Application Data
(63) Continuation of application No. PCT/GB2021/000089, filed on Aug. 9, 2021.

(30) Foreign Application Priority Data
Aug. 10, 2020 (GB) 2012388.1

(51) Int. Cl. G01L 1/22; G01L 1/20; G01B 7/16

(52) U.S. Cl. CPC G01L 1/2287; G01L 1/205; G01B 7/18

(57) ABSTRACT

A force sensing device comprises a first conductive layer and a second conductive layer and a pressure sensitive active layer responsive to a mechanical interaction. A force distribution structure is positioned between the first and second conductive layers and extends between a first end and a second end of the first conductive layer. The force distribution structure is configured to expand the contact area between the pressure sensitive active layer and the first conductive layer in response to a force being applied to the force sensing device.

### CROSS REFERENCE TO RELATED APPLICATIONS

This application is a continuation of and claims priority to International Patent Application number PCT/GB2021/000089, filed on 9 Aug. 2021, which claims priority from United Kingdom Patent Application number GB 20 12 388.1, filed on 10 Aug. 2020. The whole contents of International Patent Application number PCT/GB2021/000089 and United Kingdom Patent Application number GB 20 12 388.1 are incorporated herein by reference.

### BACKGROUND OF THE INVENTION

The present invention relates to a force sensing device, a method of manufacturing the force sensing device and a method of testing the force sensing device.

Conventional force sensing devices comprising first and second conductive layers and a third, active pressure sensitive layer, which are responsive to mechanical interactions such as a force or pressure applied are known in the art. In real-world applications, the typical area-force response to a mechanical interaction has limited dynamic range of force sensitivity compared to the dynamic range measured under laboratory conditions. In the latter case, the dynamic response provides a smooth increase in contact area with increase in force leading to increased sensitivity.

An example of a conventional force sensing device is found in US 2020/035388 A1 (ROBERTS JASON [GB] ET AL) which describes a force sensitive resistor having first and second electrical contacts which are spaced apart from one another with a layer of deformable material between the two contacts.

US 2014/076063 A1 (LISSEMAN JASON [US] ET AL) describes a sensor comprising a substrate, conductive elements and an electroactive layer. The electroactive layer defines an electrical property which is configured to vary in relation to a magnitude of pressure. It is desirable to improve the pressure sensitivity of current force sensing devices by improving the dynamic response.

### BRIEF SUMMARY OF THE INVENTION

According to a first aspect of the present invention, there is provided a force sensing device.

According to a second aspect of the present invention, there is provided a method of testing a force sensing device.

According to a third aspect of the present invention, there is provided a method of manufacturing a force sensing device.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an exploded schematic view of a force sensing device;

FIG. 2 shows a schematic side view of the force sensing device of FIG. 1;

FIG. 3 shows a method of testing the force sensing device shown in FIGS. 1 and 2 by means of an elastic actuator;

FIG. 4 shows the application of a distributed force by means of the elastic actuator of FIG. 3;

FIG. 5 shows an alternative force sensing device in a method of testing utilizing a hemispherical probe;

FIG. 6 shows a substantially similar force sensing device to the force sensing device of FIG. 5 in a method of testing utilizing an elastic actuator;

FIG. 7 shows an area-force curve illustrating the different dynamic responses of the embodiments shown in FIGS. 4, 5 and 6; and

FIG. 8 shows a logarithmic area-force curve corresponding to the embodiments of FIGS. 4, 5 and 6.

### DETAILED DESCRIPTION OF EMBODIMENTS OF THE INVENTION

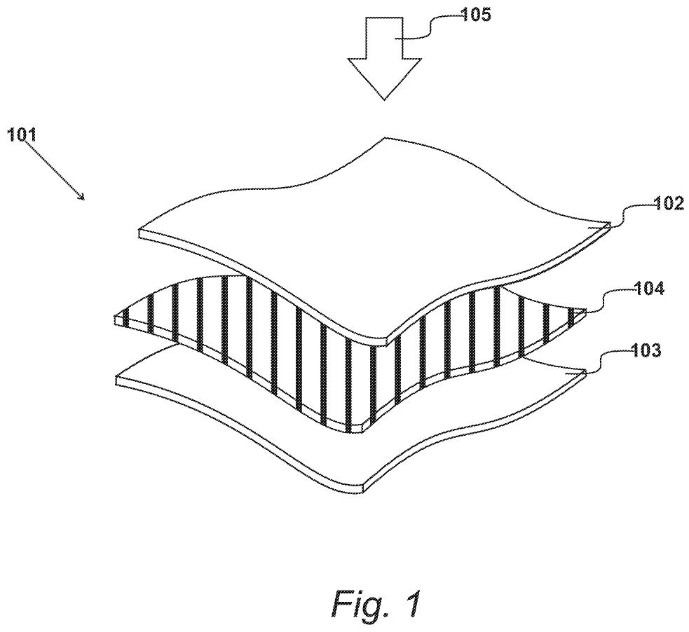

### FIG. 1

A force sensing device 101 comprises a first conductive layer 102 and a second conductive layer 103. Force sensing device 101 is further provided with a pressure sensitive active layer 104 which is responsive to a mechanical interaction and is positioned between conductive layer 102 and conductive layer 103. In FIG. 1, force sensing device 101 is shown in a schematic exploded view for illustrative purposes.

In the embodiment, conductive layer 102 and conductive layer 103 each comprise a conductive material. In an embodiment, the conductive material comprises a metallic material such as silver-based printable ink or a carbon-based material such as a carbon-based printable ink. It is appreciated that, in an embodiment, the metallic materials of the first and second conductive layers may be substantially similar or substantially different.

Pressure sensitive active layer 104 comprises a pressure sensitive material, and in an embodiment, the pressure sensitive material comprises a quantum tunnelling material. In an embodiment the pressure sensitive material comprises a printable ink. Examples of suitable materials can be obtained from the present applicant, Peratech Holdco Limited, Brompton-on-Swale, United Kingdom.

Quantum tunnelling materials of this type are responsive to a mechanical interaction in that, when a force is applied, they exhibit a change in electrical resistance which can be used to measure the nature of the force applied. It is appreciated that other pressure sensitive materials may be utilized which also exhibit a change in resistance on application of an applied force.

In use, the layers of force sensing device 101 are held in close proximity such that, when a mechanical interaction, such as a force or pressure, is applied to, for example, the top surface of conductive layer 102 in the direction of arrow 105, an electric current is transmitted through conductive layer 102 and active layer 104 to conductive layer 103. In the absence of such a mechanical interaction, the conductive layers are held apart by the active layer and an electric current is not transmitted. Thus, when connected to a suitable electric circuit known in the art, the response to the mechanical interaction can be utilized to calculate the magnitude of the mechanical interaction and in some embodiments, the position of the mechanical interaction.

In an embodiment, force sensing device 101 is typically formed as a force sensing device having a substantially circular cross-section when viewed from above. However, it is appreciated that, in alternative embodiments, force sensing device 101, may comprise an alternative cross-sectional area, such as a substantially square-shaped cross-sectional area. Pressure sensitive active layer 104 may comprise a plurality of force sensing elements, thereby enabling the magnitude of an applied force in the direction of arrow 105 to be calculated.

The dynamic range of force sensitivity of conventional force sensing devices of this type is in part dependent on a smooth increase in contact area between conductive layer 102 and conductive layer 103 with increase in force or pressure applied. Thus, the present invention aims to adapt these layers compared to conventional force sensing devices so as to optimize the increase in contact area between first and second conductive layers 102 and 103, thereby improving the dynamic range.

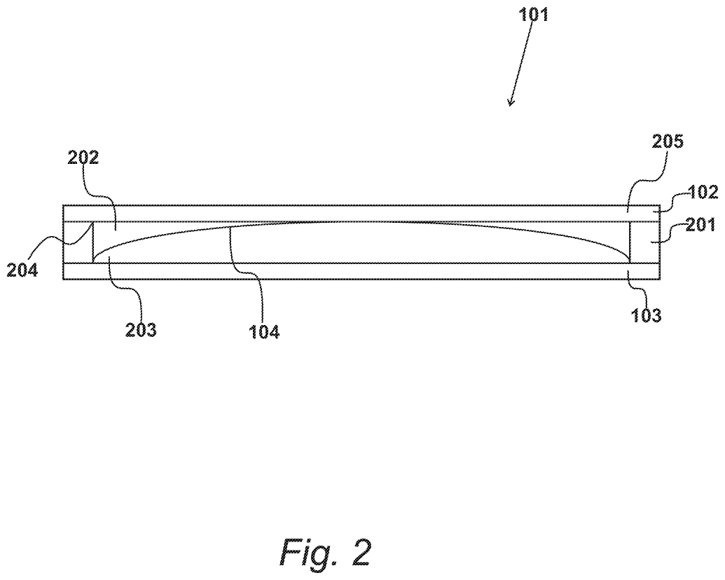

Consequently, in the present invention, force sensing device 101 further comprises a force distribution structure which is configured to extend an applied force across active layer 104, and expand the contact area between pressure sensitive active layer 104 and conductive layer 102 as will be described in further detail in FIGS. 2 to 4.

### FIG. 2

A further schematic side view of force sensing device 101 is shown in FIG. 2. Force sensing device 101 comprises conductive layer 102 and conductive layer 103 which are spaced apart by spacer gasket 201. Thus, between conductive layer 102 and conductive layer 103 is air gap 202 which maintains a space between conductive layer 102 and conductive layer 103.

Positioned between conductive layer 102 and conductive layer 103 is pressure sensitive active layer 104 and a force distribution structure 203 configured to extend a force applied across pressure sensitive active layer 104. Force distribution structure 203 is configured to expand the contact area between pressure sensitive active layer 104 and conductive layer 102 in response to a force, such as force 105, being applied to the force sensing device 101.

In the embodiment, force distribution structure 203 is not only positioned between conductive layer 102 and conductive layer 103, but also extends between a first end 204 and a second end 205 of conductive layer 102 thereby permitting expansion of the force and increasing across the whole of the layer and increasing the contact area between the conductive layer 102 and pressure sensitive active layer 104.

The embodiment of FIG. 2 shows the force sensing device 101 in an uncompressed state in which a force or pressure has not been applied. Thus, force distribution structure 203 is retained between the two conductive layers in a rest configuration.

In the embodiment, force distribution structure comprises a substantially dome-shaped cross-section as shown. It is appreciated that alternative cross-sections may be utilized that also allow for an applied force to be extended across pressure sensitive active layer 104. Thus, while a three-dimensional dome-shaped hemispherical cross-section is suitable in this case, alternatively dimensioned hemispherical cross-sections may be utilized along with other suitable shapes.

In addition, the force distribution structure 203 is axially symmetrical about a center axis. Force distribution structure 203 also comprises a substantially rigid material.

In the embodiment, pressure sensitive active layer 104 is formed as part of the force distribution structure which comprises a pressure sensitive material applied over a solid three-dimensional structure. The pressure sensitive material may be applied to an upper surface of the force distribution structure 203 to form the pressure sensitive active layer 104. Thus, in this way, the pressure sensitive material may be printed over the substantially rigid material of force distribution structure 203.

In an alternative embodiment, force distribution structure 203 itself is comprised of a pressure sensitive material which forms the entire structure. In this embodiment, the force distribution structure 203 may be considered the pressure sensitive active layer 104 such that the force distribution structure can be considered to provide the pressure sensitive active layer.

In an embodiment, the pressure sensitive material comprises a quantum tunnelling material such as that previously identified as available from the present applicant, Peratech Holdco Limited.

In the embodiment, conductive layer 102 and conductive layer 103 each comprise a conductive ink which is printed onto a substrate. In the embodiment, the substrate comprises polyethylene terephthalate (PET).

Thus, in manufacture, a first substrate is provided and a conductive ink is printed onto the first substrate to produce conductive layer 102. A further substrate is then provided and a conductive ink is printed onto the second substrate to produce conductive layer 103.

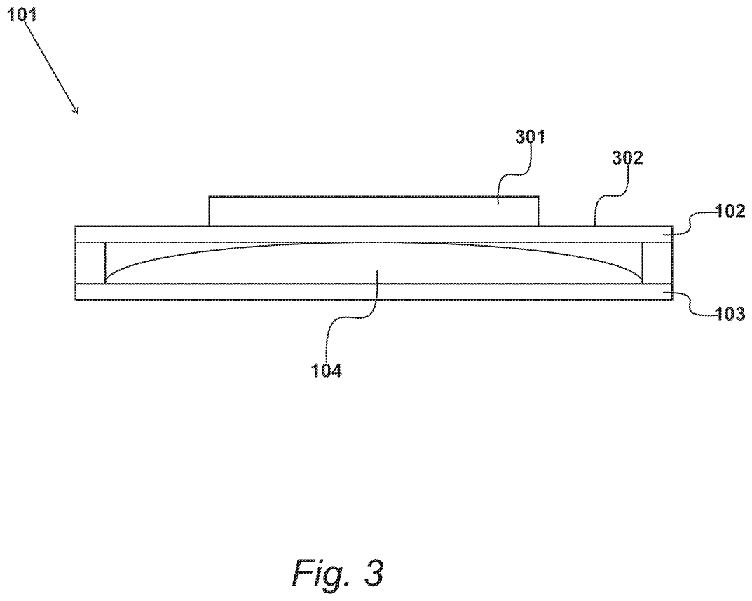

### FIG. 3

In use, force sensing device 101 may be activated by the application of an elastic actuator 301 to a top surface 302 of conductive layer 102 to provide a mechanical interaction to force sensing device 101. This method of testing the force sensing device 101 simulates a pressure or force applied to force sensing device 101 which may take the form of a finger press of a user of a force sensing device or similar in accordance with the present invention.

FIG. 3 therefore shows the elastic actuator 301 positioned for an application of a force for transmission to force sensing device 101 to conductive layer 102, pressure sensitive active layer 104 and conductive layer 103. In this example, force sensing device is shown in an uncompressed state whereby a force is yet to be applied.

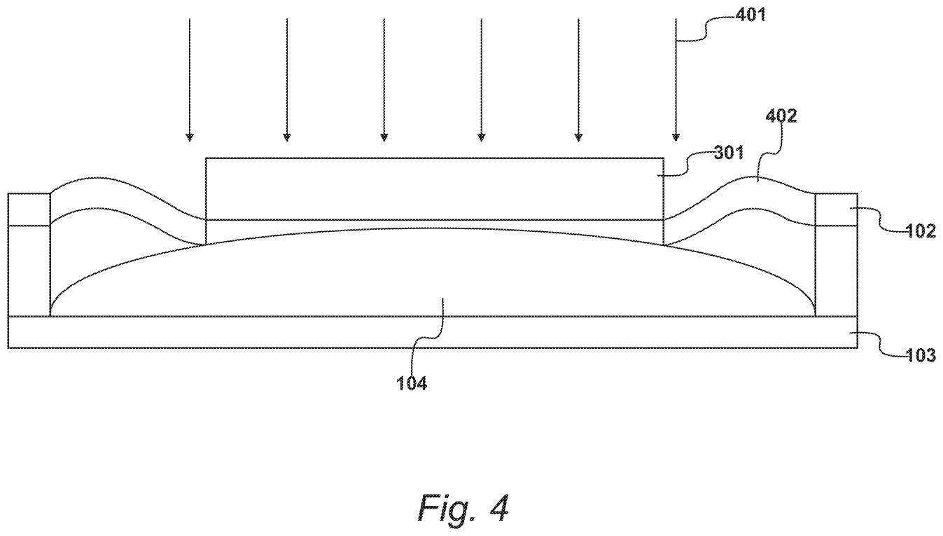

### FIG. 4

A distributed force 401 is applied by means of elastic actuator 301 as shown in FIG. 4 moving the force sensing device form the uncompressed state of FIG. 3 to the compressed state of FIG. 4.

In the embodiment, a force 401 is uniformly applied to upper surface 402 of conductive layer 102. This deforms conductive layer 102 which, due to the nature of the force distribution structure 302 is spread across a larger cross-sectional area of conductive layer 102. As indicated, this deforms conductive layer 102, however, the application of force is distributed across conductive layer 102 thereby altering the spread of force.

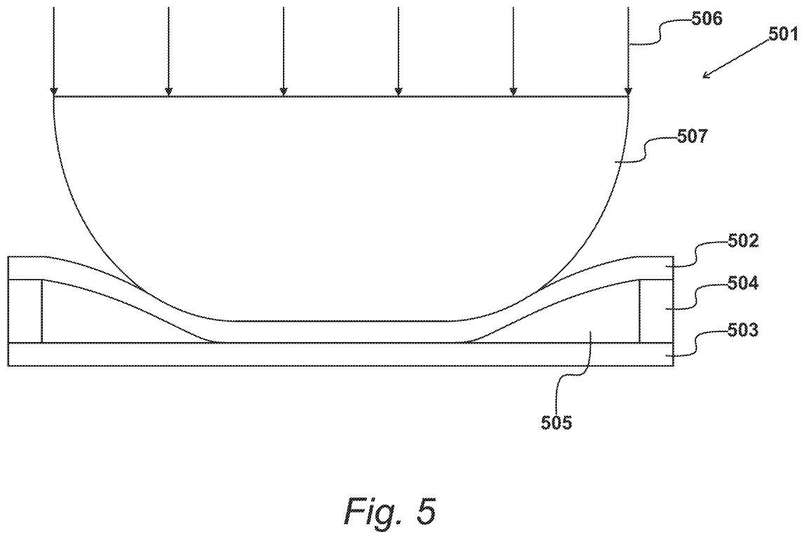

### FIG. 5

FIG. 5 illustrates a typical conventional set-up for a method of testing a force sensing device which typically gives a positive dynamic range for a force sensing device as used in real-world applications. FIG. 5 shows a conventional force sensing device 501 comprising conductive layer 502 and conductive layer 503 which are spaced apart by means of a spacer gasket 504. Spacer gasket 504 separates conductive layers 502 and 503 and creates an air gap 505 therebetween.

A hemispherical probe is shown to illustrate the effects on a force sensing device without a force distribution structure in which a force is applied 506 by means of hemispherical probe 507. Thus, in this embodiment, force sensing device 501 is shown in a compressed state.

In this embodiment, the deformation of conductive layer 502 brings conductive layer 502 into contact with conductive layer 503 in the manner shown.

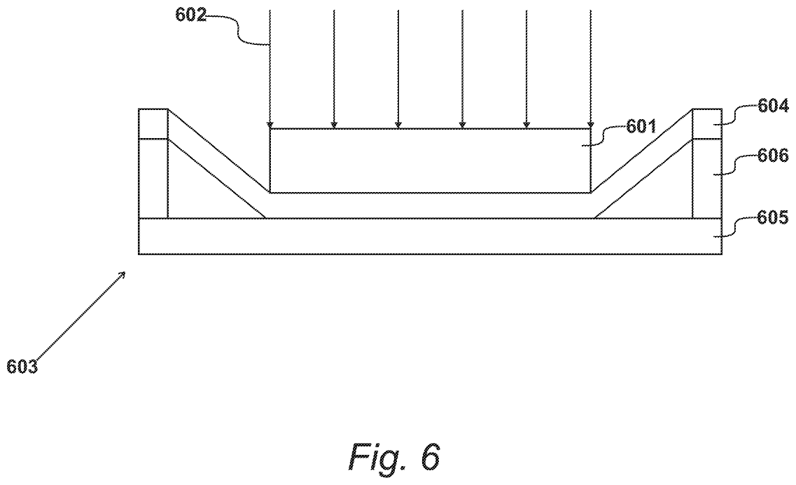

### FIG. 6

FIG. 6 shows a conventional set-up for a method of testing a force sensing device utilizing an elastic actuator. Thus, as an alternative to probe 507 which applies distributed force 506, a flat elastic actuator 601 is utilized to apply distributed force 602.

Again, the force sensing device 603 comprises a first conductive layer 604 and second conductive layer 605 which are spaced apart by means of a spacer gasket 606. Force sensing device 603 is shown in a compressed state.

Thus, first conductive layer 604, in response to a force 602 from actuator 601, brings conductive layer 604 into contact with conductive layer 605.

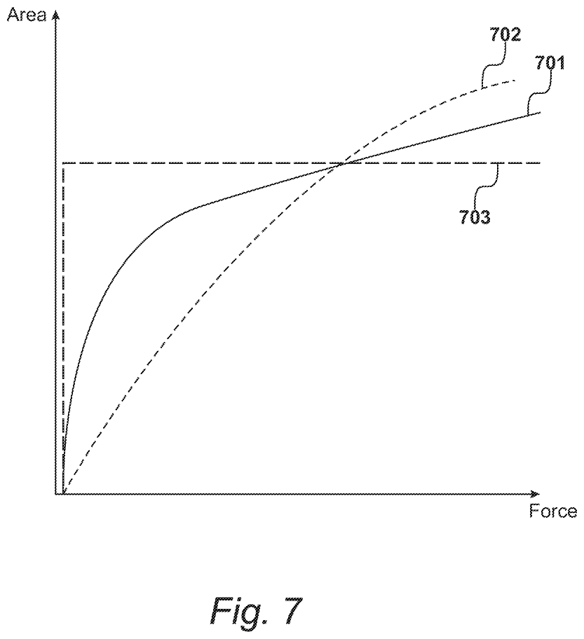

### FIG. 7

FIG. 7 shows an area-force curve illustrating the different dynamic responses of the embodiments shown in FIGS. 4, 5 and 6. Curve 701 corresponds to the embodiment and present invention of FIG. 4. Curve 702 corresponds to the embodiment shown in FIG. 5, and curve 703 corresponds to the embodiment shown in FIG. 6.

Referring first to curve 702, which corresponds to the hemispherical probe 507 being used on a force sensing device not comprising a force distribution structure of the present invention. In this embodiment, the area-force response indicates that the contact area increases proportionally to the input force. In this way, as the probe applies a force, the first and second layers make initial contact which gradually expands outwards with deformation of the probe actuator 507.

In contrast, the response of the embodiment of FIG. 6, again for a force sensing device without a force distribution structure and using elastic actuator 601, indicates that as the actuator applies force 602 first conductive layer and second conductive layer make full contact immediately with no subsequent increase in contact area for further increase in applied force.

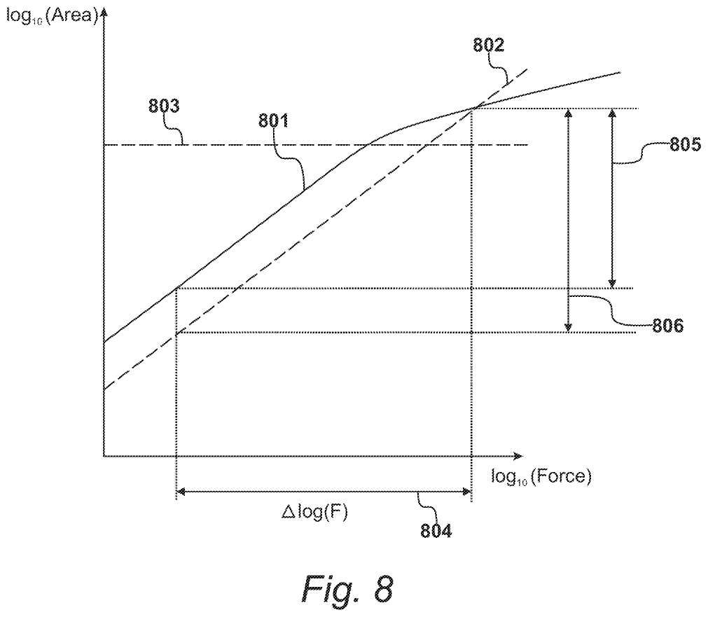

Thus, by including the force distribution structure in the present invention, curve 701 can be produced which indicates a reasonable approximation of the probe response. In this way, as the elastic actuator 301 applies distributed force 401, the contact expands outwards conforming to force distribution structure 302. Consequently, the area-force dynamic range corresponds to the size of the increase in area for a given increase in force. This will be illustrated further in the corresponding logarithmic area-force curve in FIG. 8.

### FIG. 8

A logarithmic (log₁₀) area-force curve is shown in respect of FIG. 8. Curve 801 corresponds to the embodiment of FIG. 4, curve 802 corresponds to the embodiment of FIG. 5 and curve 803 corresponds to the embodiment of FIG. 6.

The logarithmic scale illustrates the area-force dynamic range and its relationship to the size of the increase in area for a given increase in force.

An increase in contact area distributed across the conductive layer therefore provides an increase in distributed force. In the case of curve 803, it can also be noted that there is a zero area-force dynamic range for the example of FIG. 6 as the change in area for any given force is zero, as illustrated by the lack of gradient to curve 803.

In contrast, for an increase in force 804, curve 801 shows an increase in contact area 805 and curve 802 shows an increase in contact area 806.

The force sensing device of the present invention therefore provides a force distribution structure within the force sensing device which simulates the force distribution of conventional structures. Thus, even when a conventional elastic actuator is utilized to apply a force across the force sensing device a dynamic range is achieved unlike in conventional procedures as illustrated by the example in FIG. 6. This ensures a smooth gradual increase of the effective dynamic range thereby allowing for more sensitive readings to be taken and improve the sensitivity range of the force sensing device.

The invention claimed is:

1. A force sensing device, comprising:
a first conductive layer and a second conductive layer;
a pressure sensitive active layer responsive to a mechanical interaction, said pressure sensitive active layer comprising a pressure sensitive material; and
a force distribution structure positioned between said first conductive layer and said second conductive layer, said force distribution structure extending between a first end and a second end of said first conductive layer; wherein
said force distribution structure is configured to expand a contact area between said pressure sensitive active layer and said first conductive layer in response to a force being applied to said force sensing device; and further wherein
said pressure sensitive material is applied to an upper surface of said force distribution structure to form said pressure sensitive active layer.

2. The force sensing device of claim 1, wherein said force distribution structure comprises a substantially dome-shaped cross section.

3. The force sensing device of claim 1, wherein said force distribution structure is axially symmetrical.

4. The force sensing device of claim 1, wherein said pressure sensitive material comprises a quantum tunnelling material.

5. The force sensing device of claim 1, wherein at least one of said first conductive layer or said second conductive layer comprises a substrate.

6. The force sensing device of claim 5, wherein said substrate comprises polyethylene terephthalate.

7. The force sensing device of claim 1, wherein said first conductive layer and said second conductive layer are spaced apart by a spacer gasket.

8. The force sensing device of claim 1, wherein said force distribution structure comprises a substantially rigid material.

9. A method of testing a force sensing device, comprising steps of:
providing the force sensing device of claim 1; and
applying an elastic actuator to a top surface of said first conductive layer to provide said mechanical interaction to said force sensing device.

10. A method of manufacturing a force sensing device comprising steps of:
providing a first conductive layer and a second conductive layer;
providing a pressure sensitive material responsive to a mechanical interaction between said first conductive layer and said second conductive layer; and
positioning a force distribution structure between said first conductive layer and said second conductive layer such that said force distribution structure extends between a first end and a second end of said first conductive layer; wherein said step of providing said pressure sensitive material comprises a step of:
applying said pressure sensitive material to an upper surface of said force distribution structure.

11. The method of claim 10, wherein said step of applying said pressure sensitive material comprises printing said pressure sensitive material onto said upper surface of said force distribution structure.

12. The method of claim 10, wherein said force distribution structure comprises a substantially dome-shaped cross section.

13. The method of claim 10, further comprising steps of:
providing a first substrate;
printing a conductive ink onto said first substrate to produce said first conductive layer;
providing a second substrate; and
printing a second conductive ink onto said second substrate to produce said second conductive layer.
